(19) United States
(12) Patent Application Publication
(10) Pub. No.: US 2004/0012242 A1
(43) Pub. Date: Jan. 22, 2004

(54) Vehicle seat belt system

(75) Inventor: Brennon L. White, Commerce, MI (US)

Correspondence Address: FOLEY & LARDNER, 150 WEST JEFFERSON AVENUE, SUITE 1000, DETROIT, MI, 48226-4443, US

(73) Assignee: Johnson Controls Technology Company

(21) Appl. No.: 10/199,877

(22) Filed: Jul. 19, 2002

(51) Int. Cl. B60R 22/12

(52) U.S. Cl. 297/484

(57) ABSTRACT

A four point seat belt system includes a first seat belt and a second seat belt, each anchored at two points. A first retractor is coupled to the first seat belt proximate one of the anchor points and a second retractor is coupled to the second seat belt proximate one of the anchor points. A buckle releasably couples the first and second seat belts and the first and second retractors automatically retract the first and second seat belts to position the buckle at a point centered on a seat occupant's torso. The four point seat belt system can be operated using only one hand similar to a three point seat belt system.

### FIELD OF THE INVENTION

The present invention relates to a vehicle seat belt system. In particular, the present invention relates to a four point safety harness for a vehicle seat.

### BACKGROUND OF THE INVENTION

Vehicle seats, such as those used in automobiles, sport utility vehicles, minivans, trucks, and other vehicles require a seat belt that is anchored to the frame of the vehicle or the vehicle seat, or some combination thereof. Numerous varieties of seat belt systems are known.

The typical vehicle seat belt is a three point system and commonly includes a lap belt connected between an inboard buckle and an outboard anchor, and a shoulder belt connected between the inboard buckle and an outboard anchor proximate the outboard shoulder of the occupant. A retractor is generally disposed at the outboard shoulder position, and serves to retract the seat belt webbing—when the seat belt is not in use the webbing is fully retracted into a (retracted position)—and to pull the seat belt into a snug position against the occupant when the seat belt is in the use or deployed position. Conventionally, the shoulder belt and lap belt comprise a single section of webbing divided by a belt clasp, slidably carried on the seat belt webbing, that serves as the connection point to the inboard seat belt buckle. This three point systems has a single retractor in the outboard shoulder position.

Although three point seat belt systems are used in the vast majority of vehicle applications, four point safety harnesses have certain advantages over three point systems. Several advantages relate to comfort and safety, but obstacles must be overcome in the design of four point systems before use in vehicles becomes more prevalent, since four point systems are less user friendly.

Four point seat belts have four attachment points. The attachment points are typically proximate both the inboard and outboard shoulder of the seat occupant, and proximate the inboard and outboard lap positions of the occupant. Further, the belts of four point safety harnesses typically cross or meet at the chest of the seat occupant.

Four point safety harnesses are known to provide superior occupant protection in the case of a vehicle impact. Four point harnesses retain the occupant better in the seat and reduce the torque on the torso of the occupant as both shoulders are equally restrained to the seat. Further, the four attachment points spread and support impact loads in a superior fashion to three point harnesses. Additionally, in the case of a vehicle rollover, a four point harness better prevents the seat occupant from sliding out of the seat when the vehicle is overturned.

Depending on the configuration, four point seat belt systems may also be more comfortable than three point seat belt systems, especially for female seat occupants. The added comfort is a result of the angle of travel and position of the shoulder belts across the chest of the occupant.

Four point safety harnesses have been difficult to design for convenient use in mass produced vehicles, particularly when the seat belts are anchored to the frame of the vehicle. A three point harness has a single shoulder belt that may be attached at the outboard side of the seat to the B-pillar of the vehicle. However, adding a fourth point to the seat belt system presents a significant design challenge as there is no convenient attachment point on the vehicle frame for an inboard shoulder belt anchor. However, some vehicle seats are now designed to permit integrated seat belt systems that are anchored to the seat itself rather than the vehicle frame.

Despite the advent of seats having integrated seat belt system capabilities the use of four point harnesses has not greatly increased, in part due to the difficulties associated with buckling such systems. While a three point harness can generally be donned using one hand in one motion, four point harnesses typically require the user to make multiple maneuvers and connections or the use of both hands for buckling, which have prevented four point harnesses from being commercially accepted. Exemplary four point harness systems include those having two shoulder straps that each must be buckled on one side of the occupant's lap, and those having two shoulder/lap belts that meet in the center of the occupant's lap. In each case, the user must take multiple actions and/or use both hands to buckle the four point harness. Because the necessity of taking multiple actions or using both hands dissuades occupants from utilizing the seat belt system, such four point harnesses are not used in commercial vehicles.

Accordingly, it would be advantageous to have a four point seat belt system that is easy for the seat occupant to attach. More specifically, it would be advantageous to have four point safety harness that the seat occupant can properly don using one hand.

It would be desirable to provide a vehicle seat belt system and method that provides one or more of these and other advantageous features. Other features and advantages will be made apparent from the present specification. The teachings disclosed extend to those embodiments that fall within the scope of the appended claims, regardless of whether they accomplish one or more of the aforementioned needs.

### SUMMARY OF THE INVENTION

An exemplary embodiment of the present invention relates to a vehicle seat. The vehicle seat includes a cushion and a seat back. An inboard seat belt is anchored at an inboard upper and an inboard lower position, the inboard seat belt having an inboard buckle. An outboard seat belt is anchored at an outboard upper and an outboard lower position, the outboard seat belt having an outboard buckle releasably locked to the inboard buckle. A first retractor is coupled to the inboard seat belt and a second retractor is coupled to the outboard seat belt. The first retractor and the second retractor combine to center the combination of the inboard and outboard buckles in a location preferably aligned with a seat occupant's chest.

Another embodiment of the present invention relates to a four point seat belt system. The four point seat belt system includes a first seat belt and a second seat belt, each anchored at two points, the four anchor points disposed proximate a first or inboard shoulder location, a second or inboard lap location, a third or outboard shoulder location, and a fourth or outboard lap location. A first retractor is coupled to the first seat belt proximate one of the first and second anchor points. A second retractor is coupled to the second seat belt proximate one of the third and fourth anchor points. A buckle releasably couples the first and the second seat belts and the first and second retractors retract the first and second seat belts and position the buckle at a point.

A further embodiment of the present invention relates to a method of donning a four point seat belt. The method includes providing a four point seat belt having a first buckle portion and a second buckle portion, the second buckle portion disposed at an attachment point on the four point seat belt. The method further includes the steps of moving the first buckle portion to the location of the second buckle portion, connecting the first buckle portion to the second buckle portion; releasing the second buckle portion, and positioning the combination of the first buckle portion and the second buckle portion at a central position on a seat occupant.

A still further embodiment of the present invention relates to a vehicle seat having a cushion, a seat back and a four point seat belt. A safety harness is anchored at four points and has a retracted position and a deployed position. The safety harness further has a pair of buckle portions configured to releasably attach to one another. The vehicle seat further has means for retaining one of the buckle portions in a position for receiving the other buckle portion when the safety harness is in the retracted position, and means for automatically adjusting the buckle portions into a central location when the safety harness is in the deployed position.

Alternative exemplary embodiments relate to other features and combinations of features as may be generally recited in the claims.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is a front view of a vehicle seat having a four point seat belt in a retracted configuration;

FIG. 2 is a front view of a vehicle seat having a four point seat belt in a partially deployed configuration;

FIG. 3 is a front view of a vehicle seat having a four point seat belt in a deployed configuration;

FIG. 4 is a front view of a vehicle seat having a four point seat belt in a partially retracted configuration;

FIG. 5 is a schematic representation of a four point seat belt system according to a second embodiment;

FIG. 6 is a schematic representation of the four point seat belt system of FIG. 5 in a partially retracted position;

FIG. 7 is a schematic representation of a four point seat belt system according to a third embodiment; and

FIG. 8 is a schematic representation of the four point seat belt system of FIG. 7 in a partially retracted position.

### DETAILED DESCRIPTION OF EXEMPLARY EMBODIMENTS

Referring to FIG. 1, a vehicle seat 10 typically includes a cushion 12 and a seat back 14. Supporting the cushion 12 and seat back 14 is a seat frame (not shown). The seat 10 may be made in a variety of configurations depending on the intended use. For example, seats 10 are used in different positions in a vehicle such as the front driver and passenger positions and the rear passenger positions. Further, seats 10 may be used in many types of vehicles. The seat 10 is typically attached to a vehicle floor utilizing an attachment system known in the art such as stationary attachment legs or a slidable rail system.

Further referring to FIG. 1, seat 10 may include a four point seat belt system. The four point seat belt system may include an inboard belt 20 having an inboard buckle 22. An inboard retractor 24 is coupled to one end of the inboard belt 20 and is configured to retract inboard belt 20 and remove any slack therein. The inboard belt 20 is further attached to seat 10 at an inboard anchor point 26. Note that in FIG. 1, one end of inboard belt 20 is attached to seat 10 at anchor point 26, but could also be attached to other structures within a vehicle configured to provide one of the four anchor points for the four point seat belt system. The particular type of anchorage used to anchor inboard belt 20 at anchor point 26 is not depicted in FIGS. 1-4. The anchorage assembly may be any of a variety of types of anchorages known in the art.

Note that the use of “inboard” and “outboard” descriptions for the various elements of four point seat belt system is exemplary. In alternative embodiments of the four point seat belt system, the relative locations of the various elements may be changed and still fall within the scope of the claims set forth herein.

Further referring to FIG. 1, the four point seat belt system includes an outboard belt 40 having a outboard buckle 42 connected thereto. An outboard retractor 44 is coupled to the seat 10 at an outboard shoulder position. The outboard retractor 44 includes a mechanism designed to remove slack from the outboard belt 40. The outboard belt 40 is coupled to the seat 10 at an outboard anchor point 46. Note that the outboard retractor 44 and outboard anchor point 46 are shown disposed on seat 10 but could also be coupled to a vehicle frame such as by having the outboard anchor point 46 attached to a vehicle floor and the outboard retractor 44 attached to the B-pillar of an automobile. The types of anchorages may be any of a variety of types of anchorages known in the art.

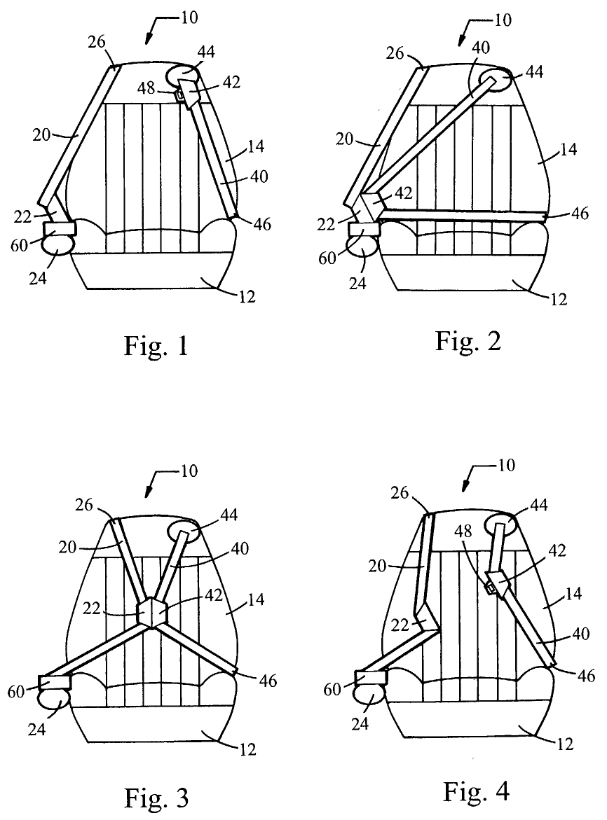

Further referring to FIG. 1, in an exemplary embodiment, a receptacle 60 is coupled proximate the inboard retractor 24 and is configured to house inboard buckle 22 in a particular orientation when the inboard belt 20 is in a retracted position. Referring to FIGS. 1 and 2, when a seat occupant desires to couple the inboard buckle 22 and outboard buckle 42 together, the occupant pulls the outboard buckle 42 toward the inboard buckle 22 and latches the two buckles 22, 42 together. Accordingly, the receptacle 60 holds inboard buckle 22 in a position configured to properly receive the outboard buckle 42. The receptacle 60 performs this function by receiving and holding inboard buckle 22 in the proper position when the inboard belt 20 is in the retracted position. Further, the receptacle 60 resists movement of inboard buckle 22 such that a seat occupant may insert outboard buckle 42 into inboard buckle 22 with one hand without holding inboard buckle 22 steady during the process.

Receptacle 60 may be part of inboard retractor 24, such as an extension thereof in an exemplary embodiment. The receptacle 60 may utilize any one of a number of methods to retain the inboard buckle 22 in an orientation allowing easy access for outward buckle 42 such as an interference fit, snap fit, magnetic connection, or other methods known in the art.

Inboard buckle 22 and outboard buckle 42 are coupled together by any one of several locking mechanisms known in the art. For example, as shown in FIG. 1, outboard buckle 42 may include a latch plate 48 that is inserted into a corresponding recess (not shown) within inboard buckle 22 to lock the two buckles together until the user activates a release button (not shown).

Referring to FIGS. 1-3, a vehicle seat occupant dons the four point seat belt system in the following manner. The retracted orientation of the four point seat belt system is depicted in FIG. 1 with the inboard buckle 22 held within receptacle 60 and the outboard buckle 42 held proximate outboard retractor 44. The buckles 22, 42 are held in position due to the tension forces supplied by each retractor 24, 44. Once a seat occupant is positioned in the seat 10, the occupant may grasp outboard buckle 42 with one hand and pull the buckle 42 and associated outboard belt 40 across the body of the occupant and insert the outboard buckle 42 into the inboard buckle 22 such that the two buckles 22, 42 latch together (see FIG. 2). The vehicle seat occupant then may release outboard buckle 42, permitting the outboard retractor 44, in conjunction with inboard retractor 24, to center the latched inboard buckle 22 and outboard buckle 42 on the vehicle seat occupant's torso or chest. The centered position is depicted in FIG. 3.

Referring to FIGS. 3 and 4, a vehicle seat occupant dons the four point seat belt by unlatching inboard buckle 22 from outboard buckle 42. The inboard retractor 24 and outboard retractor 44 are then free to retract inboard belt 20 and outboard belt 40 and thereby pull inboard buckle 22 and outboard buckle 42 back into the retracted orientation depicted in FIG. 1.

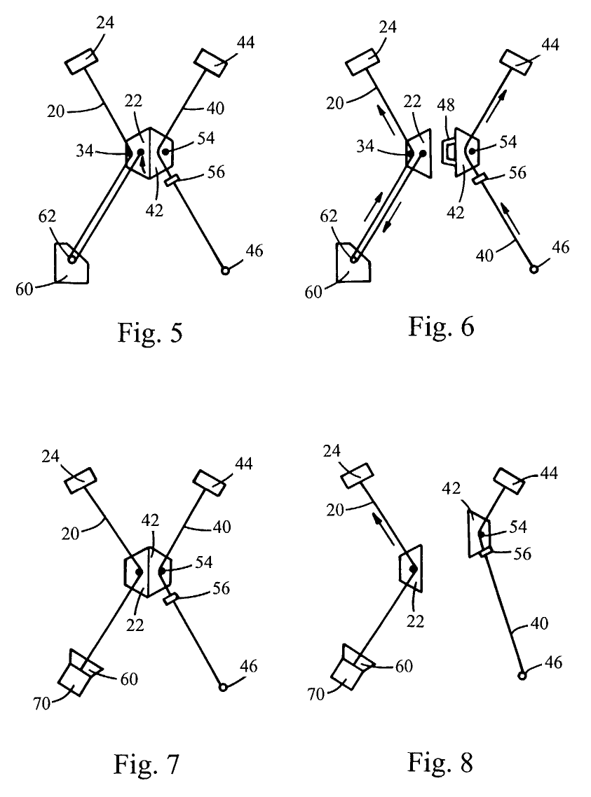

FIGS. 5 and 6 depict a second exemplary embodiment of the four point seat belt system utilizing inboard retractor 24 and outboard retractor 44 to effectuate the desired system. In the depicted embodiment, inboard retractor 24 is disposed at an inboard shoulder position, and outboard retractor 44 is disposed at an outboard shoulder position. Inboard belt 20 is fixed to inboard buckle 22 at one end, is successively wrapped around receptacle slide loop 62, inboard buckle slide loop 34, and is affixed at the other end within inboard retractor 24. The arrows following inboard belt 20 in FIG. depict the direction of tension applied by inboard retractor 24.

Further referring to FIG. 5, outboard belt 40 is fixed at one end at outboard anchor point 46, travels through outboard buckle slide loop 54 and is fixed at the other end to outboard retractor 44. The arrows following outboard belt 40 in FIGS. 5 and 6 depict the direction of tension applied by outboard retractor 44.

Referring to FIG. 6, the direction of travel of inboard belt 20 and outboard belt 40 as the four point seat belt system moves from the deployed into the retracted position is depicted by the arrows along each belt 20, 40. The retractors 24, 44 retract belts 20, 40, and subsequently pull buckles 22, 42 into their retracted positions. Receptacle 60 is designed to properly house inboard buckle 22 in a configuration designed to receive outboard buckle 42. In the present embodiment, inboard buckle 22 does not travel with belt 20 past receptacle 60 because buckle 22 is not sized to travel around receptacle slide loop 62. Outboard retractor 44, belt 40, and buckle 42 travel in a similar manner to conventional three point seat belt systems, and includes an outboard position holder 56 to maintain the position of outboard buckle 42 proximate outboard retractor 44 when in the retracted position.

Referring to FIGS. 7 and 8, a third embodiment of a four point seat belt system is depicted having three retractors, inboard retractor 24, outboard retractor 44, and a third retractor 70. In the embodiment depicted in FIGS. 7 and 8, third retractor 70 is disposed at the inboard lap position and may be attached to a vehicle seat or vehicle frame depending on the desired design configuration. In the embodiment of FIG. 7, inboard belt 20 is fixed with respect to inboard buckle 22 at an intermediate position on belt 20. The outboard belt 40, buckle 42, and retractor 44 are configured in a similar manner to that described with respect to FIG. 5, including slide loop 54 and position holder 56.

In an exemplary embodiment, both inboard retractor 24 and outboard retractor 44, and third retractor 70 may be emergency locking retractors that are activated to prevent movement of inboard belt 20 and outboard belt 40 when the vehicle encounters sudden, greater than normal, acceleration forces.

Referring to FIG. 8, when inboard buckle 22 is detached from outboard buckle 42, retractors 24 and 70 combine to pull the inboard buckle 22 into position within receptacle 60. The arrows along inboard belt 20 depict the direction of tension on inboard belt 20, and the double arrow in the direction of third retractor 70 indicates that the retraction force of third retractor 70 is greater than that of inboard retractor 24, and accordingly, inboard buckle 22 is pulled to rest properly within receptacle 60 rather than toward inboard retractor 24.

In the three exemplary embodiments described herein, the various retractors are designed to automatically pull the inboard and outboard buckles 22, 42, into a centered position on the seat occupant's body after the occupant has inserted outboard buckle 42 into inboard buckle 22, latching the two buckles together. Adjusting the retraction forces and positioning the retractors to accomplish the centering function serves the purpose of permitting the one-handed operation of the disclosed four point seat belt system invention because the occupant need only grasp outboard buckle 42, pull the outboard buckle 42 across the body, insert it into inboard buckle 22, and release the combined buckles to properly don the four point seat belt. Accordingly, as discussed in the Background of the Invention section, the present invention provides a system that has the advantage of easily permitting one-handed operation.

While the detailed drawings and specific examples given describe various exemplary embodiments, they serve the purpose of illustration only. The inventions disclosed are not limited to the specific forms shown. For example, the retractor and belt configurations may differ depending on the chosen performance characteristics and physical characteristics of the four point seat belt system. For example, the seat belt system may be designed to permit the inboard buckle 22 to retract to an inboard shoulder position while the outboard buckle 42 retracts into a receptacle at the outboard lap position. Further still, the seat 10 may be a child or infant “car seat” that is separately buckled to a seat within a vehicle. The systems and methods depicted and described and not limited to the precise details and conditions disclosed. Furthermore, other substitutions, modifications, changes, and omissions may be made in the design, operating conditions, and arrangements of the exemplary embodiments without departing from the scope of the invention as expressed in the appended claims.

What is claimed is:

1. A vehicle seat, comprising:
a cushion;
a seat back;
an inboard seat belt anchored at an inboard upper and an inboard lower position, the inboard seat belt having an inboard buckle;
an outboard seat belt anchored at an outboard upper and an outboard lower position, the outboard seat belt having an outboard buckle to be releasably locked to the inboard buckle;
a first retractor coupled to the inboard seat belt; and
a second retractor coupled to outboard seat belt;
wherein the first retractor and the second retractor combine to automatically center the combination of the inboard and outboard buckles at a first location.

2. The vehicle seat of claim 1, wherein the inboard buckle is retained within a receptacle when the system is in a retracted position.

3. The vehicle seat of claim 2, wherein the receptacle is removably coupled to and extends from the first retractor.

4. The vehicle seat of claim 2, wherein the receptacle positions the inboard buckle such that the inboard buckle is prepared to receive and lock to the outboard buckle without further adjustment.

5. The vehicle seat of claim 1, further comprising a third retractor coupled to the inboard seat belt.

6. The vehicle seat of claim 5, wherein the third retractor exerts a greater force on the inboard seat belt than the first retractor, whereby the inboard buckle is automatically retained within a receptacle proximate the third retractor.

7. The vehicle seat of claim 6, wherein the third retractor is disposed at the inboard lower position and the first retractor is disposed at the inboard upper position.

8. The vehicle seat of claim 1, wherein the first and second retractors pull the inboard and outboard seat belts into a retracted position upon detachment of the inboard buckle from the outboard buckle.

9. The vehicle seat of claim 1, wherein the first retractor is disposed at the inboard upper position.

10. The vehicle seat of claim 1, wherein the first retractor is disposed at the inboard lower position.

11. The vehicle seat of claim 10, wherein the second retractor is disposed at the outboard upper position.

12. The vehicle seat of claim 1, wherein the vehicle seat is a child vehicle seat.

13. A four point seat belt system, comprising:
a first seat belt and a second seat belt, each anchored at two points, the four anchor points disposed proximate an inboard shoulder location, an inboard lap location, an outboard shoulder location, and an outboard lap location, respectively;
a first retractor coupled to the first seat belt proximate one of the anchor points;
a second retractor coupled to the second seat belt proximate one of the anchor points; and
a buckle releasably coupling the first and the second seat belts;
wherein the first and second retractors automatically retract the first and second seat belts, respectively, to position the buckle at a center point.

14. The four point seat belt system of claim 13, further comprising a third retractor coupled to the first seat belt.

15. The four point seat belt system of claim 13, further comprising a third retractor coupled to the first seat belt at the end opposite the first retractor.

16. The four point seat belt system of claim 14, wherein the third retractor is located proximate the inboard lap location and the first retractor is located proximate the inboard shoulder location.

17. The four point seat belt system of claim 15, wherein the third retractor exerts a greater force on the first seat belt than the force exerted by the first retractor, whereby an inboard portion of the buckle is automatically retained within a receptacle proximate the third retractor when the buckle is separated and the four point seat belt system is in a retracted position.

18. The four point seat belt system of claim 13, wherein the buckle comprises a first portion and a second portion; and four point seat belt system further comprising a receptacle that retains the first portion of the buckle when the first seat belt is in a retracted portion.

19. The four point seat belt system of claim 13, wherein the four point seat belt system is applied to one of an infant and a child vehicle seat.

20. The four point seat belt system of claim 13, wherein the first retractor is located proximate the inboard shoulder location.

21. The four point seat belt system of claim 13, wherein the first retractor is located proximate the inboard lap location.

22. The four point seat belt system of claim 13, wherein the first retractor is located proximate the outboard shoulder location.

23. A method of donning a four point seat belt, comprising:
providing a four point seat belt having a first buckle portion and a second buckle portion, the second buckle portion initially located at an attachment point of the four point seat belt;
grasping the first buckle portion;
moving the first buckle portion to the location of the second buckle portion;
connecting the first buckle portion to the second buckle portion; and
releasing the second buckle portion from the attachment point,
wherein the four point seat belt automatically positions the combination of the first buckle portion and the second buckle portion at a central position on a seat occupant's chest.

24. The method of claim 22, wherein the second buckle portion is retained within a receptacle prior to connecting with the first buckle portion.

25. The method of claim 22, further comprising the step of placing a child seat in the seat and donning the four point seat belt to a child in the child seat.

26. The method of claim 22, wherein the step of connecting the first buckle portion to the second buckle portion is performed with one hand.

27. A vehicle seat having a four point belt, comprising:
a cushion;
a seat back;
a safety harness anchored at four points having a retracted position and a deployed position, the safety harness having a pair of buckle portions configured to releasably attach to one another;
means for retaining one of the buckle portions in a position for receiving the other buckle portion when the safety harness is in the retracted position; and
means for automatically adjusting the buckle portions into a central location when the safety harness is in the deployed position.

28. The vehicle seat of claim 26, wherein the safety harness is attached at each of the four points to the vehicle seat.

29. The vehicle seat of claim 26, wherein the safety harness is attached at one or more of the four points to a vehicle frame.

30. The vehicle seat of claim 26, wherein the means for automatically adjusting comprises a plurality of retractors.

31. The vehicle seat of claim 26, wherein the means for automatically adjusting comprises three retractors.

32. The vehicle seat of claim 26, wherein the means for retaining comprises a buckle receptacle.

33. A safety restraint system, comprising:
an inboard seat belt anchored at an inboard upper and an inboard lower position, the inboard seat belt having an inboard buckle;
an outboard seat belt anchored at an outboard upper and an outboard lower position, the outboard seat belt having an outboard buckle for releasably locking with the inboard buckle;
a first retractor coupled to the inboard seat belt; and
a second retractor coupled to outboard seat belt;
wherein the first retractor and the second retractor combine to automatically center the combination of the inboard and outboard buckles on a seat occupant's chest.

34. The vehicle seat of claim 32, wherein the inboard buckle is retained within a receptacle when the system is in a retracted position.

35. The vehicle seat of claim 32, wherein inboard buckle is movable on the inboard seat belt and the outboard buckle is movable on the outboard seat belt.

36. The vehicle seat of claim 32, wherein inboard buckle is fixed in position on the inboard seat belt and the outboard buckle is fixed in position on the outboard seat belt.

37. The vehicle seat of claim 32, further comprising a third retractor coupled to the inboard seat belt.

38. The vehicle seat of claim 36, wherein the third retractor exerts more tension on the seat belt than the first retractor, whereby the inboard buckle is automatically retained within a receptacle proximate the third retractor.

39. The vehicle seat of claim 37, wherein the third retractor is disposed at the inboard lower position and the first retractor is disposed at the inboard upper position.
